(19) United States
(12) Patent Application Publication
(10) Pub. No.: US 2024/0229330 A9
(43) Pub. Date: Jul. 11, 2024

(54) DRUM-TYPE WASHING MACHINE HAVING SOFTENING APPARATUS

(71) Applicant: Samsung Electronics Co., Ltd., Suwon-si (KR)

(72) Inventors: Atsushi OHYAGI, Yokohama (JP); Hitoshi MINAI, Yokohama (JP); Takashi ANDO, Yokohama (JP); Tomoyuki OKUNO, Yokohama (JP); Yasushi URAI, Yokohama (JP)

(21) Appl. No.: 18/397,879

(22) Filed: Dec. 27, 2023

Related U.S. Application Data
(63) Continuation of application No. PCT/KR2022/007586, filed on May 27, 2022.

(30) Foreign Application Priority Data
Jul. 29, 2021 (JP) 2021-124364

(51) Int. Cl. D06F 39/00; C02F 1/42; D06F 23/02; D06F 34/22; D06F 39/02; D06F 39/12

(52) U.S. Cl. CPC D06F 39/007; C02F 1/42; D06F 23/02; D06F 34/22; D06F 39/02; D06F 39/12; D06F 2103/20

(57) ABSTRACT

A disclosed drum-type washing machine having a softening apparatus comprises: a cylindrical water tank accommodating laundry and having a rotating drum; a case for accommodating the water tank; and a softening apparatus having a hardness component remover for removing hardness components from washing water, and a regeneration agent accommodation unit spaced apart from the hardness component remover on opposite sides from a center of the tub, and for accommodating a regeneration agent that regenerates a function of the hardness component remover.

### CROSS-REFERENCE TO RELATED APPLICATIONS

This application is a Bypass Continuation of International Application No. PCT/KR2022/007586, filed May 27, 2022, which claims priority to Japan Patent Application No. 2021-124364, filed Jul. 29, 2021, the disclosures of which are herein incorporated by reference in their entirety.

### BACKGROUND

### 1. Field

The disclosure relates to a drum type washing machine with a water softening device.

### 2. Description of Related Art

As in Europe, there are many regions where tap water is hard water with high hardness (containing large amounts of minerals such as calcium (Ca), magnesium (Mg), etc.). In such an area, the efficiency of detergent is lowered, and thus, its cleaning ability is reduced. To solve these problems, several drum type washing machines equipped with a water softening device to soften tap water have thus far been proposed.

In a drum type washing machine disclosed in Patent Document 1 (Japanese Patent Application Publication No. 2001-87592), a detergent dispenser and a water softening device are arranged side-by-side in a front-rear direction at positions corresponding to an upper portion of a washing tub inside a casing. The water softening device includes a salt reservoir for holding salt and an ion exchange resin container for holding ion exchange resins. The water softening device is located behind the detergent dispenser. The salt reservoir and the ion exchange resin container are arranged to overlap each other in a vertical direction. Tap water is supplied into the salt reservoir to produce brine (salt water), and the brine is introduced into the ion exchange resin container to regenerate ion exchange resins.

In a drum type washing machine disclosed in Patent Document 2 (US Patent Application 2015-0204005), a detergent dispenser and a water softening device are arranged side-by-side in a horizontal direction at positions corresponding to an upper portion of a washing tub inside a casing. In detail, the detergent dispenser and the water softening device are arranged at left and right sides of a front wall of the casing, respectively so that they may be respectively drawn out in a front direction. The drum type washing machine in Patent Document 2 is the same as that in Patent Document 1 in that a salt reservoir for holding salt and an ion exchange resin container for holding ion exchange resins, which are included in the water softening device, are arranged to overlap each other in a vertical direction.

Salts or detergents are consumables. Thus, each time a residual amount of detergent or salt decreases, a new detergent or salt needs to be introduced into the detergent dispenser or salt reservoir. Accordingly, the detergent dispenser or the salt reservoir is located in an upper portion of the casing and on the front wall of the casing in terms of workability.

However, in the drum type washing machine, a large washing tub having a cylindrical shape is located horizontally (in the front-rear direction) inside the casing when a laundry entrance is opened on the front wall of the casing. In general, a diameter of the washing tub is designed to correspond to a total area of the casing, and the washing tub is located further toward an upper side of the casing considering workability when loading and unloading laundry. As a result, for the drum type washing machine, an upper region of the casing above the washing tub generally has a small vertical width (a width in a vertical direction thereof).

Furthermore, a control panel is located on a front wall of the upper portion of the casing of the drum type washing machine. Also, the control panel is required to have a largest possible area considering user convenience, and it is necessary to secure a space for installing electric components inside the casing at the rear of the control panel.

In other words, for the drum type washing machine, various parts need to be densely arranged on the upper region of the casing having a narrow vertical width considering workability and operability.

On the other hand, because the detergent dispenser and the salt reservoir are respectively required to hold large amounts of detergent and salt, it is desirable for them to have largest possible capacities. Thus, when these are arranged on the front surface of the upper portion of the casing, like in the drum type washing machine of Patent Document 2, an area of the control panel has to be reduced, which may deteriorate user convenience.

On the other hand, in the drum type washing machine in Patent Document 1, the detergent dispenser has the salt reservoir located therein, and is integrated with a brine container on the back thereof, which removably accommodates a salt container for receiving salt. In this case, to put salt into the salt container, a vertically elongated case including the detergent dispenser needs to be pulled out to a great extent toward a front side of the casing. Even when the salt container is removed from the brine container, it is difficult to work therewith. The vertically elongated, large case is difficult to handle and easy to break.

### SUMMARY

The disclosure provides a drum type washing machine with a water softening device, which provides improved convenience of loading a regeneration agent.

According to an embodiment of the disclosure, a washing machine includes: a tub having a cylindrical shape and including a rotating drum configured to receive laundry; a casing including a receiving region in which the tub is accommodated, an upper region above the receiving region, and four corner regions arranged around the tub; and a water softening device including a hardness component remover configured to remove hardness components from wash water and a regeneration agent container unit spaced apart from the hardness component remover on opposite side of a center of the tub and configured to hold a regeneration agent for regenerating a function of the hardness component remover.

In an embodiment of the disclosure, the regeneration agent container unit may be located in a first of the four corner regions. In an embodiment of the disclosure, the hardness component remover may be located in a second of the four corner regions that is different from the first of the four corner regions.

In an embodiment of the disclosure, the four corner regions may include first and second corner regions adjacent to the upper region and laterally spaced apart from each other on opposite sides from the center of the tub, and the regeneration agent container unit and the hardness component remover may be respectively arranged in the first and second corner regions.

In an embodiment of the disclosure, the drum type washing machine may further include a detergent container case provided between the water softening device and the tub and holding detergent. The detergent container case may be located in the upper region. The regeneration agent container unit may be located below the detergent container case.

In an embodiment of the disclosure, the detergent container case may include a detergent container accommodated in the detergent container case to be withdrawable from a front side of the casing in order to load the detergent.

In an embodiment of the disclosure, the detergent container case may be located further toward one side of the upper region in a lateral direction with respect to the center of the tub. The four corner regions may include first and second corner regions adjacent to the upper region and laterally spaced apart from each other on opposite sides from the center of the tub. The regeneration agent container unit may be located in the first corner region below the detergent container case.

In an embodiment of the disclosure, the regeneration agent container unit may have a substantially inverted triangular cross-section.

In an embodiment of the disclosure, the regeneration agent container unit may include a dissolution tank and a regeneration agent container accommodated in the dissolution tank and configured to be withdrawable from the front side of the casing in order to load the regeneration agent.

In an embodiment of the disclosure, a regeneration agent inlet capable of being opened or closed may be provided on the front side of the casing to load the regeneration agent into the regeneration agent container unit. The drum type washing machine may further include an auxiliary loader detachable from the regeneration agent inlet to load a given amount of the regeneration agent into the regeneration agent container unit. The regeneration agent container unit may include a dissolution tank. The auxiliary loader may include an insertion portion inserted into the dissolution tank through the regeneration agent inlet. A volume of an upper space in the dissolution tank above a lower end of the insertion portion may be greater than or equal to an internal volume of the auxiliary loader.

In an embodiment of the disclosure, the water softening device may include: a pool tank provided between the detergent container case and the hardness component remover and temporarily holding soft water; a water supply path connecting the pool tank to the regeneration agent container unit; and a pump configured to supply the soft water from the pool tank to the regeneration agent container unit and supply water treated for regeneration from the regeneration agent container unit to the pool tank.

In an embodiment of the disclosure, the pump may include a peristaltic pump capable of bidirectionally supplying water.

In an embodiment of the disclosure, a first check valve that allows fluid to flow from the pool tank to the regeneration agent container unit is arranged in parallel in the water supply path to a second check valve that allows fluid to flow from the regeneration agent container unit to the pool tank may be arranged parallel to each other in the water supply path. In an embodiment of the disclosure, the pump includes a first pump configured to transfer the fluid from the pool tank to the regeneration agent container unit and a second pump configured to transfer the fluid from the regeneration agent container unit to the pool tank.

In the drum type washing machine according to the embodiments of disclosure, the convenience of loading a regeneration agent thereinto may be enhanced. Components of the drum type washing machine may be arranged by efficiently utilizing a space inside the washing machine. A water supply path for a water softening device may be simplified.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a front view of a drum type washing machine 1 according to an embodiment of the disclosure.

FIG. 2 is a schematic side cross-sectional view of the drum-type washing machine 1 of FIG. 1.

FIG. 3 is a partial perspective view of an upper region of a casing.

FIG. 4 is a schematic exploded perspective view of the automatic detergent dispensing device 10 according to an embodiment of the disclosure.

FIG. 5 is a schematic diagram of the water softening device 2 according to an embodiment of the disclosure.

FIG. 6 is a perspective view of a hardness component remover according to an embodiment of the disclosure.

FIG. 7 shows a state in which a washing machine supplies water when a water softening function of a water softening device is appropriate, according to an embodiment of the disclosure.

FIG. 8 shows a main state during regeneration by the water softening device 2 according to an embodiment of the disclosure.

FIG. 9 is a perspective view of a regeneration agent container unit 60 according to an embodiment of the disclosure.

FIG. 10 is a partial perspective view of a regeneration agent container unit 60 according to an embodiment of the disclosure.

FIG. 11 shows schematic diagrams of a drum type washing machine according to an embodiment of the disclosure.

FIG. 12 shows examples of a combination of a water supply path and a pump.

### DETAILED DESCRIPTION

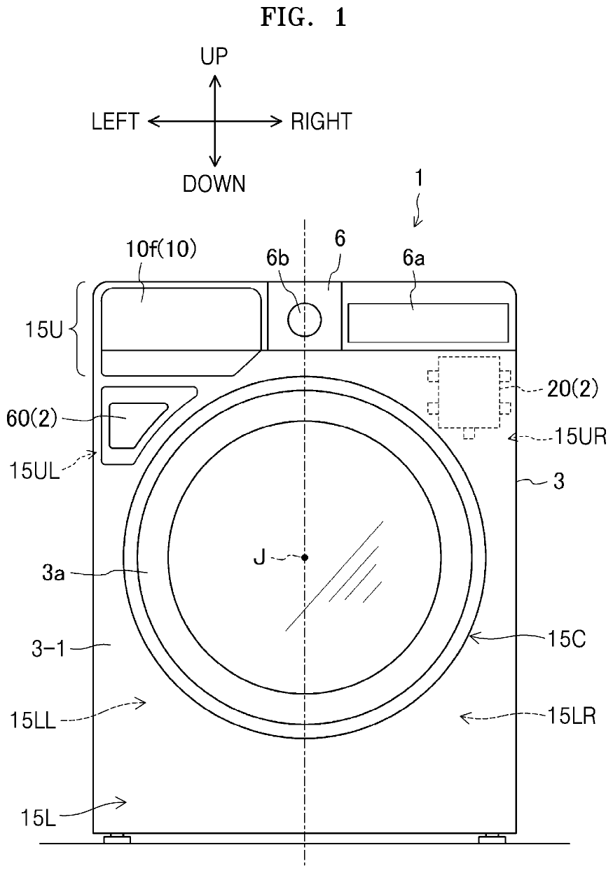

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the disclosure are general terms currently widely used in the art based on functions described in the disclosure, but may have different meanings according to an intention of one of ordinary skill in the art, precedent cases, advent of new technologies, etc. Furthermore, some particular terms may be arbitrarily selected by the applicant, and in this case, the meaning of the selected terms will be described in detail in the detailed description of the disclosure. Thus, the terms used herein should be defined not by simple appellations thereof but based on the meaning of the terms together with the overall description of the disclosure. Throughout the specification, when a part “includes” or “comprises” an element, unless there is a particular description contrary thereto, it is understood that the part may further include other elements, not excluding the other elements.

Embodiments of the disclosure will be described more fully hereinafter with reference to the accompanying drawings so that they may be easily implemented by one of ordinary skill in the art. However, the disclosure may be implemented in different forms and should not be construed as being limited to the embodiments set forth herein. In addition, parts not related to descriptions of the disclosure are omitted to clearly explain embodiments of the disclosure in the drawings, and like reference numerals denote like elements throughout. The following description is for illustrative purposes only and is not intended to limit the disclosure, applications thereof, or its purposes. Directions such as front and rear, left and right, and up and down used in the description are based on a case in which a normal drum-type washing machine is viewed from a front side.

<Overall Configuration of a Drum Type Washing Machine>

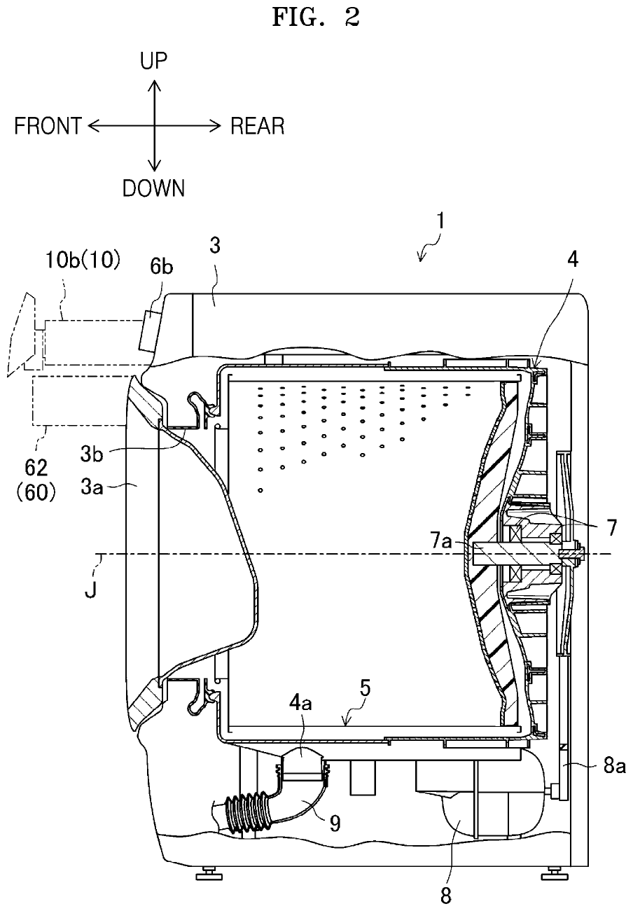

FIG. 1 is a front view of a drum type washing machine 1 according to an embodiment of the disclosure. FIG. 2 is a schematic side cross-sectional view of the drum-type washing machine 1 of FIG. 1. The washing machine 1 may be a fully-automatic washing machine capable of automatically performing a series of washing, rinsing, and spin-drying processes. The washing machine 1 may have a drying function.

The washing machine 1 may include a tub 4 having a cylindrical shape and including a drum 5 that is rotatable and receives laundry to be washed, a water softening device 2 that softens wash water and supplies the softened water to the tub 4, and a casing 3 that accommodates components of the washing machine 1 to form an external appearance thereof. The water softening device 2 may include a hardness component remover 20 for removing hardness components from wash water supplied to the tub 4 and a regeneration agent container unit 60 for holding a regeneration agent that regenerates a function of the hardness component remover 20.

The casing 3 accommodates the components of the washing machine 1, thereby forming an external appearance thereof. The casing 3 may have a substantially rectangular parallelepiped shape. For example, the casing 3 may be formed by assembling plate-shaped panels in a rectangular frame. An inlet 3b is provided on a front side 3-1 of the casing 3. The laundry may be put into or taken out of the drum 5 inside the tub 4 through the inlet 3b. A door 3a is provided to the front side 3-1 of the casing 3 to open and close the inlet 3b.

The casing 3 may include a receiving region 15C in which the tub 4 is accommodated, an upper region 15U above the receiving region 15C, and four corner regions, i.e., first through fourth corner regions 15UL, 15UR, 15LL, and 15LR, arranged around the tub 4. The first and second corner regions 15UR and 15UL are adjacent to the upper region 15U and laterally spaced apart from each other on opposite sides from a center of the tub 4. The third and fourth corner regions 15LR and 15LL are respectively located below the first and second corner regions 15UR and 15UL and laterally spaced apart from each other on the opposite sides from the center of the tub 4. The inlet 3b may be located further toward an upper portion of the front side 3-1 of the casing 3 than a lower portion of the front side 3-1 of the casing for convenience. Accordingly, of the casing 3, among the inner regions of the casing 3, the upper region 15U, and in particular, the region above the tub 4 in the casing 3, has a small height in a vertical direction (a vertical width). A control panel 6, an automatic detergent dispensing device 10 (an example of a detergent dispenser case), a water supply pipe 12, etc. are provided in the upper region 15U, as described below.

The tub 4 is a cylindrical container having a bottom, which is installed inside the casing 3 and capable of storing water. The tub 4 is provided in the casing 3 so that a central axis J of the tub 4 extends in a front-rear direction. An opening of the tub 4 is aligned with the inlet 3b. The bottom of the tub 4 faces an opposite side of the inlet 3b. The tub 4 is elastically supported on the casing 3 by a plurality of springs and a plurality of dampers. Thus, the tub 4 is shaken during washing. A specific anti-interference space is provided around the tub 4 to prevent the tub 4 from interfering with the casing 3 and other components accommodated in the casing 3 even when the tub 4 is shaken.

The drum 5 is a cylindrical container with a bottom, which is slightly smaller than the tub 4. The drum 5 is accommodated in the tub 4 with its opening facing the inlet 3b. In other words, the bottom of the drum 5 faces an opposite side of the inlet 3b. An outer wall of the drum 5 is provided with a number of water passage holes penetrating therethrough. A bearing 7 is installed at the rear of the casing 3 to rotatably support a shaft 7a penetrating the bottom of the tub 4. The drum 5 may rotate about the central axis J by supporting the bottom of the drum 5 on the shaft 7a.

The washing machine 1 includes a motor 8 for rotating the drum 5. For example, the motor 8 may be installed in a lower portion of the casing 3. For example, a drive shaft of the motor 8 may be connected to the shaft 7a via a transmission mechanism 8a including a sub-pulley, a belt, and a main pulley. Furthermore, the motor 8 may directly drive the drum 5 by connecting the motor 8 directly to the shaft 7a.

A drain path is provided in a lower region 15L of the casing 3. The drain path may include a drain hose 9 and a drain pump (not shown). An upper end of the drain hose 9 is connected to a drain port 4a provided at a lower end of the tub 4.

Various components are arranged in an inner space of the casing 3. Various components need to be efficiently arranged in the inner space of the casing 3. Operability (or workability) is considered when arranging the components. The operability may include the convenience of introducing a laundry detergent, the convenience of introducing a regeneration agent, and the convenience of controlling an operation of the washing machine 1. Components requiring user manipulation may include, for example, the detergent dispenser case 10, the water softening device 2, the control panel 6, etc. The components requiring user manipulation need to be arranged by taking into account the operability and efficient use of the inner space of the casing 3.

In the washing machine 1 according to the embodiment of the disclosure, the hardness component remover 20 and the regeneration agent container unit 60 are arranged to be spaced apart from each other on opposite sides from the center of the tub 4. The hardness component remover 20 and the regeneration agent container unit 60 are relatively large components constituting the water softening device 2. By separating the hardness component remover 20 from the regeneration agent container unit 60, the hardness component remover 20 and the regeneration agent container unit 60 may be arranged in the inner space of the casing 3 with a high degree of freedom.

When the hardness component remover 20 is integrated with the regeneration agent container unit 60, because of their large size, it is not easy to arrange the integrated hardness component remover 20 and regeneration agent container unit 60 in the upper region 15U having a small vertical width or the four corner regions, i.e., the first through fourth corner regions 15UL, 15UR, 15LL, and 15LR. In the washing machine 1 according to the embodiment of the disclosure, the hardness component remover 20 is separated from the regeneration agent container unit 60. Each of the hardness component remover 20 and the regeneration agent container unit 60 having a relatively small size may be accommodated in the upper region 15U or the four corner regions, i.e., the first through fourth corner regions 15UL, 15UR, 15LL, and 15LR. Thus, the hardness component remover 20 and the regeneration agent container unit 60 may be arranged in the inner space of the casing 3 with a high degree of freedom. For example, the regeneration agent container unit 60 may be located in one of the four corner regions 15UL, 15UR, 15LL, and 15LR while the hardness component remover 20 may be located in one of the remaining three corner regions. As described later, because water supply system components and control unit components are densely arranged in the upper region 15U, the upper region 15U has little free space, and it is difficult to arrange the integrated hardness component remover 20 and regeneration agent container unit 60 in the upper region 15U. According to this example, by separating the hardness component remover 20 from the regeneration agent container unit 60, they may be accommodated in the four corner regions with relatively small sizes, i.e., the first through fourth corner regions 15UL, 15UR, 15LL, and 15LR, thereby allowing efficient use of the inner space of the casing 3. For example, the regeneration agent container unit 60 may be located in the first corner region 15UL adjacent to the upper region 15U, and the hardness component remover 20 may be located in the second corner region 15UR laterally spaced apart from the first corner region 15UL. In this case, the hardness component remover 20 may be located in the other corner regions, i.e., the third and fourth corner regions 15LL and 15LR. However, because a smaller height difference in a vertical direction between the regeneration agent container unit 60 and the hardness component remover 20 facilitates transport of fluids, the regeneration agent container unit 60 and the hardness component remover 20 may be respectively arranged in the first and second corner regions 15UL and 15UR with a relatively small height difference.

The regeneration agent container unit 60 may have a substantially inverted triangular cross-section. The first and second corner regions 15UL and 15UR are narrow regions having a substantially inverted triangular shape when viewed in the front-rear direction. These regions are empty regions that are not used because other components are difficult to install therein. By fitting a shape of the regeneration agent container unit 60 to a shape of an empty region, e.g., the first corner region 15UL, the empty region inside the casing 3 may be effectively utilized while securing the capacity of the regeneration agent container unit 60. By arranging the hardness component remover 20 in the second corner region 15UR, the empty region may be utilized more effectively.

The washing machine 1 may include the automatic detergent dispensing device 10. The automatic detergent dispensing device 10 may include a detergent container case 10a installed between the water softening device 2 and the tub 4 and holding detergent. The detergent container case 10a may be located in the upper region 15U. The detergent container case 10a may be located more toward one side of the upper region 15U in the lateral direction with respect to the tub 4. For example, referring to FIG. 1, the detergent container case 10a is located further to the left of the upper region 15U. The detergent container case 10a may include a detergent container 10b that is withdrawable from the front side 3-1 of the casing 3 to put detergent therein. A state in which the detergent container 10b is withdrawn is indicated by a dashed line in FIG. 2. The regeneration agent container unit 60 is located in the first corner region 15UL below the detergent container case 10a. The regeneration agent container unit 60 has a structure that allows introduction of a regeneration agent at the front side 3-1 of the casing 3. Structures that allow a regeneration agent to be introduced according to embodiments of the disclosure are described later.

This configuration allows the detergent container 10b installed in the upper region 15U to be withdrawable from the front side 3-1 of the casing 3, thereby facilitating an operation of putting detergent, etc. in the detergent container 10b. Furthermore, because the detergent container case 10a is separate from the regeneration agent container unit 60, the risk of mistakenly putting detergent into the regeneration agent container unit 60 or regeneration agent into the detergent container 10b may be reduced. Furthermore, because the detergent container case 10a is located further toward one side of the upper region 15U in the lateral direction, an installation area of the control panel 6 located on one side of the detergent container case 10a in the lateral direction, e.g., on a right side thereof, may be sufficiently secured. In addition, because the control panel 6 having a large area may be located in the upper region 15U to face the front side 3-1 of the casing 3, convenience of using the control panel 6 may be improved.

An example of a structure of the washing machine 1 in which the detergent container case 10a is located further to the left of the upper region 15U, the regeneration agent container unit 60 is located in the first corner region 15UL below the detergent container case 10a, and the hardness component remover 20 is located in the second corner region 15UR is described in detail below.

(Structure of Upper Region 15U of Casing 3)

Control unit components are densely arranged in the upper region 15U of the casing 3, together with water supply system components. In detail, as described above, in the washing machine 1, the control panel 6, the automatic detergent dispensing device 10, and the like are arranged in the upper region 15U of the casing 3. In particular, the part for performing such an operation is arranged on the front side 3-1 of the casing 3.

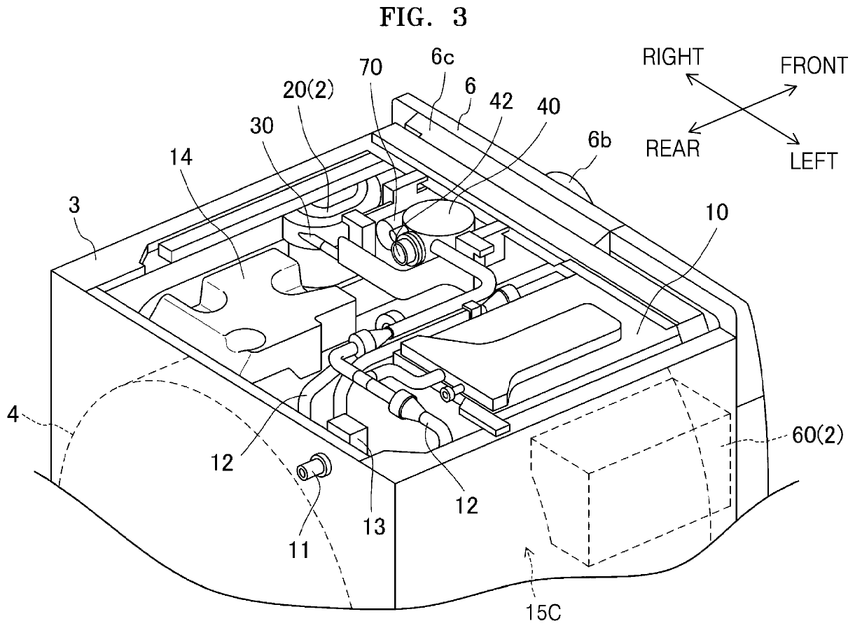

FIG. 3 is a partial perspective view of the upper region 15U of the casing 3. In the washing machine 1, a connection port 11 for supplying water is provided on a rear left corner of the casing 3. Usually, the connection port 11 is connected to a faucet of a water supply via a hose. Thus, water (wash water) used for washing may be supplied to the washing machine 1. A water supply pipe 12 (which constitutes a water supply path) is connected to the connection port 11. A water supply valve 13 is installed at an upstream end of the water supply pipe 12 and opens when water is supplied.

The water supply pipe 12 is usually located in the upper region 15U of the casing 3, and is connected to a tap water supply port (not shown) opened at an upper portion of the tub 4. The water softening device 2 and the automatic detergent dispensing device 10 are installed in the middle of the water supply pipe 12 (as described in detail later). Thus, the wash water (tap water) entering the washing machine 1 is supplied to the tub 4 through the water softening device 2 and the automatic detergent dispensing device 10.

The control panel 6 is a panel for operating the washing machine 1, and as shown in FIG. 1, may have a laterally elongated shape. The control panel 6 may include a display 6a, an operation dial 6b, and the like. The control panel 6 is arranged within a range approximately from the center of the upper region 15U to a right end thereof to face the front side 3-1 of the casing 3 for easy manipulation. An electric device such as an electronic board and a power distribution case 6c for accommodating electric wires are provided at the rear of the control panel 6.

(Automatic Detergent Dispensing Device 10)

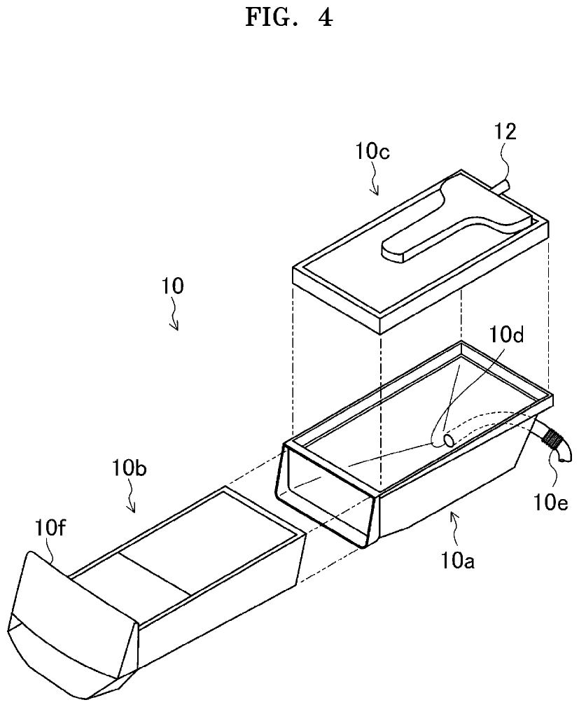

The automatic detergent dispensing device 10 is a device for automatically dispensing detergent or the like during washing. FIG. 4 is a schematic exploded perspective view of the automatic detergent dispensing device 10 according to an embodiment of the disclosure. Referring to FIGS. 3 and 4, the automatic detergent dispensing device 10 may be a rectangular parallelepiped-shaped part that is long in a front-rear direction and short in a vertical direction. The automatic detergent dispensing device 10 may include the detergent container case 10a and the detergent container 10b. The automatic detergent dispensing device 10 may be positioned further toward one side of the upper region 15U in the lateral direction. For example, the automatic detergent dispensing device 10 is located adjacent to a left side of the control panel 6 and further to the left of the upper region 15U of the casing 3. The automatic detergent dispensing device 10 is arranged in a left corner of the upper region 15U of the casing 3.

In addition, a manual detergent dispensing device without an automatic dispensing function may be employed instead of the automatic detergent dispensing device 10. For a manual detergent dispensing device, a user manually loads a single dose of detergent required for washing. For this reason, the manual detergent dispensing device has a smaller capacity than the automatic detergent dispensing device 10. In particular, the manual detergent dispensing device has a small size in the front-rear direction. Thus, the manual detergent dispensing device is more advantageous than the automatic detergent dispensing device 10 in terms of an installation space, but is the same as the automatic detergent dispensing device 10 in terms of a size in the vertical direction.

The detergent container case 10a may be a container having an opening at the front thereof. The detergent container case 10a may be mounted on the casing 3 so that the opening faces the front side 3-1 of the casing 3. A flow divider 10c having a form of a hollow plate is provided on an upper surface of the detergent container case 10a. A water supply pipe 12 is connected to the flow divider 10c. The flow divider 10c divides incoming wash water so that it flows down into the detergent container 10b.

A water passage port 10d is provided at a lower end of the detergent container case 10a. An upper end of the connection hose 10e, which constitutes a water supply path, is connected to the water passage port 10d. A lower end of the connection hose 10e is connected to a tap water supply inlet of the tub 4.

The detergent container 10b may be a tray-shaped container inserted in or withdrawn from the detergent container case 10a. As indicated by an imaginary line in FIG. 4, the detergent container 10b may be accommodated in the detergent container case 10a to be pulled forward with respect to the casing 3. A pull-out cover 10f having a handle is installed on a front surface of the detergent container 10b. The pull-out cover 10f may be exposed on the front side 3-1 of the casing 3.

Although not shown in FIG. 4, an inside of the detergent container 10b may be partitioned so as to separately hold washing agents such as detergents or fabric softeners. When wash water flows into the flow divider 10c when the detergent and the like are contained in the detergent container 10b, the detergent and the like are supplied to the tub 4 together with the wash water.

As described above, the tub 4 is shaken during washing. In order to suppress the shaking, a large weight 14 is attached to the tub 4 at a plurality of locations symmetrical with respect to the central axis J. For the washing machine 1, as shown in FIG. 3, the connection port 11 for supplying water is located at a left-rear corner of the casing 3, and the automatic detergent dispensing device 10 is positioned in front of the connection port 11. Therefore, there is no space for installing large parts in an upper left side of the casing 3. By considering this, one weight 14 is arranged in a right-rear portion of the upper portion of the casing 3.

(Water Softening Device 2)

The water softening device 2 is a device for softening wash water. The water softening device 2 is connected to the water supply pipe 12 on an upstream side relative to the automatic detergent dispensing device 10, and supplies softened wash water to the automatic detergent dispensing device 10. The water softening device 2 may include the hardness component remover 20 and the regeneration agent container unit 60.

The hardness component remover 20 holds ion exchange resins and softens the wash water by removing hardness components from the wash water. As the amount of wash water that has passed through the hardness component remover 20 increases, a function of the ion exchange resins decreases. The regeneration agent container unit 60 contains regeneration agents (usually salt in the form of particles) used to regenerate the function of the ion exchange resins.

The regeneration agents are consumables and need to be refilled. In order to facilitate refilling with regeneration agents, the water softening device 2 may be located adjacent to the upper region 15U of the casing 3, in particular, the front side 3-1 of the casing 3. However, as described above, the upper region 15U of the casing 3 has a narrow vertical width, and various components are densely arranged in the upper region 15U. Therefore, a space where the water softening device 2 may be installed in the upper region 15U of the casing 3 is limited to a region between the weight 14 and the control panel 6 on the right side thereof.

However, it is difficult to install the water softening device 2 only in the space. Even when the water softening device 2 is installed in the space, it is not easy to refill with regeneration agents. In the drum type washing machine 1 according to the embodiment of the disclosure, in order to effectively use the limited space as an arrangement space for the water softening device 2, the hardness component remover 20 and the regeneration agent container unit 60, which are relatively bulky components, are separated from each other and arranged in different regions.

In other words, when viewed from the front-rear direction, there are substantially inverted triangular or V-shaped spaces (herein referred to as the first and second corner regions 15UL and 15UR) at upper corners on left and right sides of the tub 4. The first and second corner regions 15UL and 15UR are kept relatively empty because it is difficult to install devices therein due to their lower sides forming a narrow space. In particular, because the automatic detergent dispensing device 10 is positioned above a front portion of the first corner region 15UL on the left, it is difficult to install a device therein.

By forming the regeneration agent container unit 60 to have a specific shape, the first corner region 15UL may be effectively utilized. By arranging the regeneration agent container unit 60 of a specific shape in the first corner region 15UL below the automatic detergent dispensing device 10, the regeneration agent container unit 60 having a relatively large capacity may be realized while enabling loading of regeneration agents at the front side 3-1 of the casing 3.

On the other hand, the hardness component remover 20 may be located in the second corner region 15UR on the right side of the tub 4. For example, the hardness component remover 20 may be arranged in a space between the control panel 6 and the weight 14 in the second corner region 15UR. The hardness component remover 20 is connected to the regeneration agent container unit 60 via a regeneration water pipe (constituting a water supply path).

According to an embodiment of the disclosure, the water softening device 2 may further include a pool tank 40 and a pump 70 in addition to the hardness component remover 20 and the regeneration agent container unit 60. The pool tank 40 and the pump 70 may be arranged in the space between the control panel 6 and the weight 14 in the left-right direction (lateral direction) because they are small components compared to the regeneration agent container unit 60 or the hardness component remover 20.

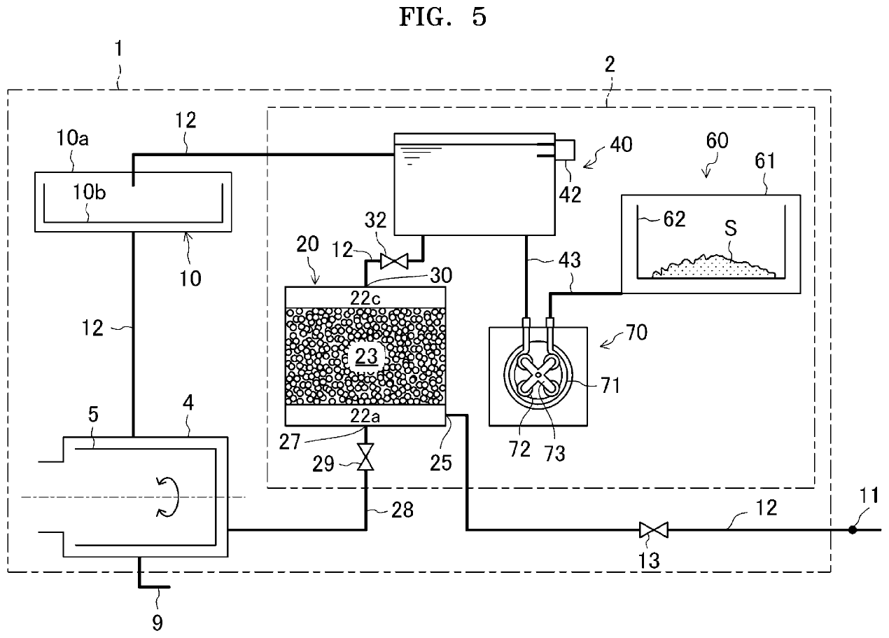

FIG. 5 is a schematic diagram of the water softening device 2 according to an embodiment of the disclosure. Referring to FIG. 5, as described above, the water softening device 2 is connected to the water supply pipe 12 on the upstream side of the automatic detergent dispensing device 10. The hardness component remover 20 is installed in the middle of the water supply pipe 12, and the pool tank 40 is connected to the water supply pipe 12 on a downstream side relative to the hardness component remover 20.

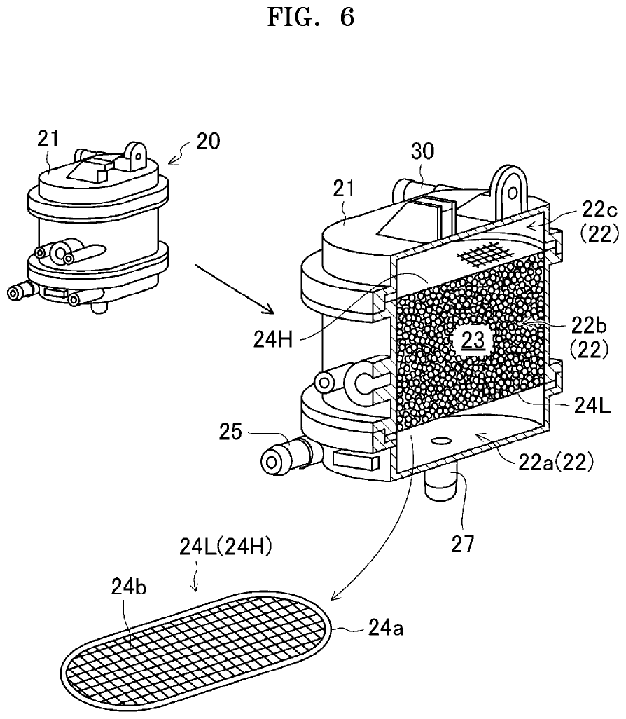

FIG. 6 is a perspective view of a hardness component remover according to an embodiment of the disclosure. Referring to FIG. 6, the hardness component remover 20 may include a resin case 21. For example, the resin case 21 may have a substantially elliptical shape when viewed from its top and a substantially rectangular shape when viewed from its side. A water passage space 22 through which water flows from a lower side toward an upper side is created in the resin case 21. The water passage space 22 has a substantially elliptical cross-section, and its cross-sectional area approximately equal from a bottom to a top.

For example, the water passage space 22 may be divided into an upstream buffer space 22a, a resin-filled chamber 22b, and a downstream buffer space 22c sequentially from the lower side to the upper side. The resin-filled chamber 22b is densely filled with a given amount of ion exchange resins 23 (agglomerates of particles) that adsorb hardness components. The upstream buffer space 22a may be partitioned from the resin-filled chamber 22b by an upstream water passage member 24L. The downstream buffer space 22c may be partitioned from the resin-filled chamber 22b by a downstream water passage member 24H.

The upstream and downstream water passage members 24L and 24H may each include a mesh member having a form of a sheet, as shown in an enlarged view of FIG. 6. A mesh member may be formed of, for example, polyester, and include an elliptical edge portion 24a and a water passage portion 24b opened in a mesh shape inside the edge portion 24a. A size of a pore for the mesh in the water passage portion 24b is smaller than a particle size of the ion exchange resin 23 so that the ion exchange resin 23 does not pass therethrough.

Each of the mesh members respectively forming the upstream and downstream water passage members 24L and 24H of the resin-filled chamber 22b may have elasticity. For example, an elongation rate of each mesh member may be 7% to 17%. The upstream and downstream water passage members 24L and 24H are respectively in contact with the upstream side buffer space 22a and the downstream side buffer space 22c. Thus, the resin-filled chamber 22b is expandable toward the upstream and downstream buffer spaces 22a and 22c. As the resin-filled chamber 22b expands, a volume of the resin-filled chamber 22b may be increased by about 10% or at least 5% or more.

A water supply inlet 25 is provided on a side of the upstream buffer space 22a. The water supply pipe 12 is connected to the water supply inlet 25. Wash water is introduced into the upstream buffer space 22a through the water supply inlet 25.

A regeneration water outlet 27 is provided on a bottom surface of the upstream buffer space 22a. An upstream end of a regeneration water discharge pipe 28 is connected to the regeneration water outlet 27. A downstream end of the regeneration water discharge pipe 28 is connected to the tub 4. A drain valve 29 controlled to open and close is installed on the regeneration water discharge pipe 28.

A soft water outlet 30 is provided on a side surface of the downstream buffer space 22c. The soft water outlet 30 is connected to the pool tank 40 via the water supply pipe 12. The pool tank 40 may be a nearly sealed container capable of storing water. The wash water softened by the hardness component remover 20, i.e., soft water, is temporarily stored in the pool tank 40.

The pool tank 40 may be located at a higher position than the hardness component remover 20. A stop valve 32 that is controlled to open and close is installed on the water supply pipe 12 between the pool tank 40 and the hardness component remover 20. The upstream end of the water supply pipe 12 connected to the automatic detergent dispensing device 10 is connected to the top of the pool tank 40.

A sensor 42 may be installed in the pool tank 40 to measure an electrical conductivity inside the pool tank 40. A level and a degree of hardness of the water collected in the pool tank 40 may be measured using the sensor 42. The pool tank 40 is connected to the regeneration agent container unit 60 through a regeneration water pipe 43 (a water supply path).

(Water Supply Path and Regeneration Agent Container Unit 60)

The regeneration agent container unit 60 may include a dissolution tank 61 capable of storing water and a regeneration agent container 62 accommodated in the dissolution tank 61. The regeneration agent container 62 contains an appropriate amount of regeneration agent S as needed. A detailed structure of the regeneration agent container unit 60 is described below.

The regeneration agent S is a water-soluble agent that regenerates the ion exchange resin 23 and is usually a salt (NaCl) particle. The regeneration agent S contained in the regeneration agent container 62 is dissolved in water collected in the dissolution tank 61. Thus, an aqueous solution (regeneration water) containing the regeneration agent S dissolved therein, i.e., a high-concentration brine, is produced in the dissolution tank 61.

The regeneration water pipe 43 has one end connected to a bottom of the dissolution tank 61. The regeneration water pipe 43 has the other end connected to a bottom of the pool tank 40. A pump 70 is installed in the middle of the regeneration water pipe 43. A peristaltic pump may be used as the pump 70. In the embodiment of the disclosure, a tube pump is used as the pump 70. Hereinafter, the pump 70 is referred to as a tube pump 70. The tube pump 70 is a known pump, and may include a tube 71 extending along a circular wall, a plurality of rollers 72 pressing the tube 71 against the circular wall, and a rotor 73 rotating the rollers 72 along the circular wall.

Both ends of the tube 71 are connected to the regeneration water pipe 43. When the rotor 73 rotates, the water inside the tube 71 is transferred through the tube 71. The rotor 73 is rotatable in a forward or reverse direction. Thus, the tube pump 70 is capable of bidirectionally supplying water. The tube pump 70 is capable of shutting off the flow of water when the tube pump 70 does not operate. In other words, the flow of water is blocked. Thus, this eliminates the need for an on/off valve for controlling water supply via the regeneration water pipe 43. Furthermore, water shut-off characteristics may be improved by installing an on/off valve on the regeneration water pipe 43.

According to the above-described configuration, water may be supplied bidirectionally through a single path (a water supply path), i.e., one regeneration water pipe 43. Thus, by installing only a single water supply path, i.e., the regeneration water pipe 43, between the pool tank 40 and the regeneration agent container unit 60, the complexity of a pipe structure may be avoided, and an adequate quantity of water may be supplied at an appropriate flow rate. When there is only one water supply path, the arrangement of the regeneration water pipe 43 is simple, and residual water in the water supply path may be suppressed from occurring. An installation position of the regeneration agent container unit 60 with respect to the pool tank 40 is not particularly limited.

(Operation of the Water Softening Device 2)

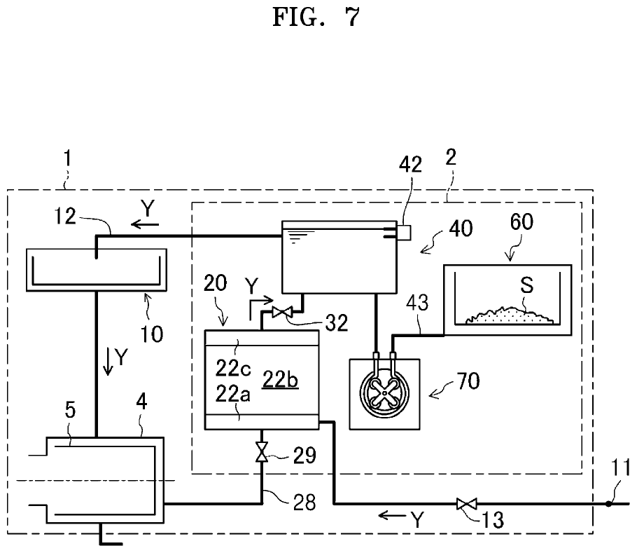

FIG. 7 shows a state in which the washing machine 1 supplies water when a water softening function of the water softening device 2 is normal, according to an embodiment of the disclosure. Referring to FIG. 7, an arrow Y indicates the flow of water. The stop valve 32 is open, and the drain valve 29 is closed. The tube pump 70 stops working. When the water supply valve 13 is opened, wash water is introduced into the water supply pipe 12 at a given water pressure.

The wash water then flows into the hardness component remover 20. As the wash water passes through the resin-filled chamber 22b, the wash water is softened by absorbing its hard components on the ion exchange resin 23. The softened wash water (also referred to as soft water) flows into the pool tank 40. When the amount of soft water exceeds a water storage capacity of the pool tank 40, the soft water is supplied to the automatic detergent dispensing device 10. The sensor 42 is provided in the pool tank 40, and may determine a deterioration of performance of the hardness component remover 20 based on a measured value. When the performance of the hardness component remover 20 deteriorates, a regeneration process is executed.

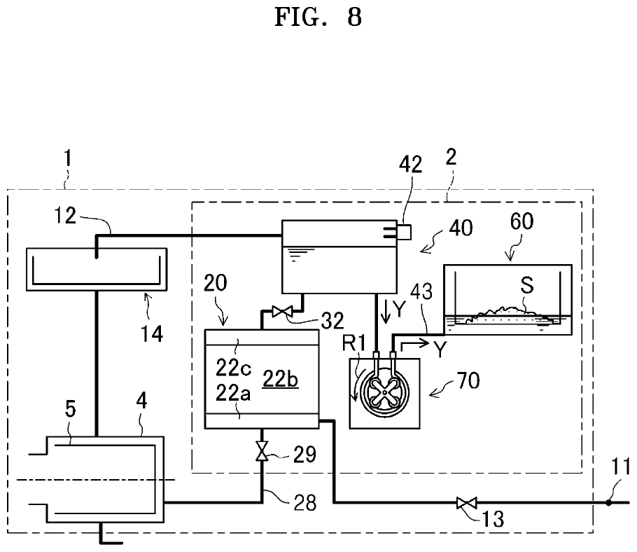

FIG. 8 shows a main state during regeneration by the water softening device 2 according to an embodiment of the disclosure. Referring to FIG. 8, in a regeneration process, regeneration water is produced in the pool tank 40, and the regeneration water passes through the hardness component remover 20. Soft water collected in the pool tank 40 is used for the regeneration process. The stop valve 32 is closed, the tube pump 70 is operated (rotated in a direction indicated by an arrow R1), and the soft water collected in the pool tank 40 is supplied to the regeneration agent container unit 60. The soft water is collected in the dissolution tank 61, and the regeneration agent S is dissolved in the soft water to produce a regeneration water that is a high-concentration brine in the dissolution tank 61.

Next, the tube pump 70 is operated in a reverse direction to supply the regeneration water collected in the dissolution tank 61 to the pool tank 40. The regeneration water is collected in the pool tank 40.

Then, the drain valve 29 and the stop valve 32 are opened. The regeneration water collected in the pool tank 40 is then introduced into the hardness component remover 20 using a natural drop, and drained into the tub 4 through the regeneration water discharge pipe 28. As the regeneration water passes through the resin-filled chamber 22b, the ion exchange resin 23 is regenerated.

(Detailed Structure of Regeneration Agent Container Unit 60)

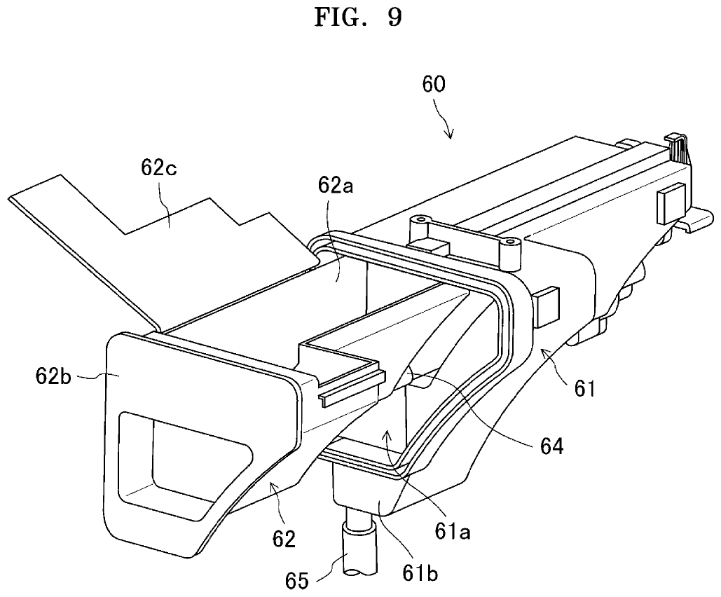

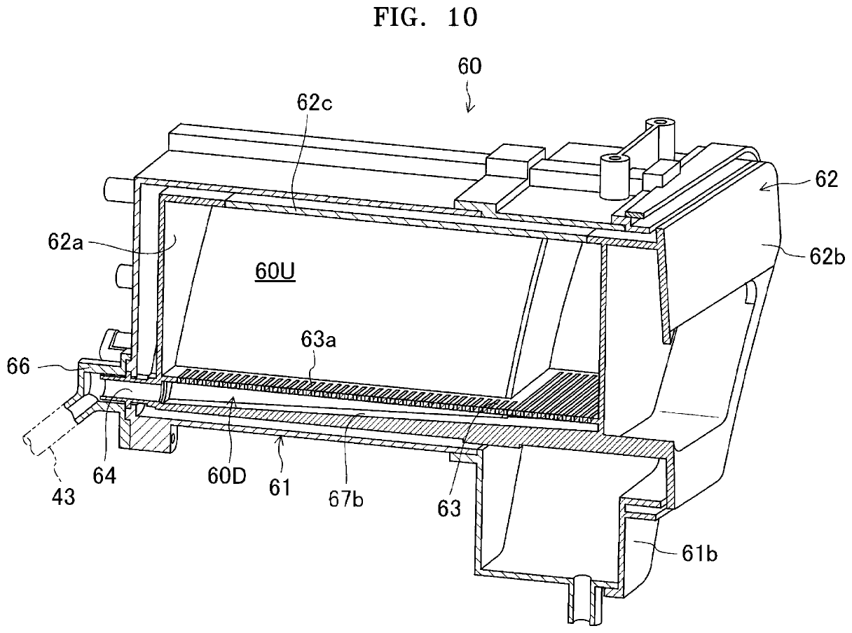

FIG. 9 is a perspective view of the regeneration agent container unit 60 according to an embodiment of the disclosure, and FIG. 10 is a partial cross-sectional view of the regeneration agent container unit 60 according to an embodiment of the disclosure. Referring to FIGS. 9 and 10, as described above, the regeneration agent container unit 60 includes the dissolution tank 61 capable of storing water and the regeneration agent container 62 accommodated in the dissolution tank 61.

The regeneration agent container unit 60 may be a laterally (front-rear direction) elongated member having a substantially inverted triangular cross-section. Accordingly, each of the dissolution tank 61 and the regeneration agent container 62 may also have a laterally (in the front-rear direction) elongated shape with a substantially inverted triangular cross-section. As shown in FIGS. 1 and 3, the regeneration agent container unit 60 may be installed to extend in the front-rear direction in the first corner region 15UL that is on the left side of the casing 3 and below the automatic detergent dispensing device 10.

The dissolution tank 61 has an opening 61a at the front, and is mounted to the casing 3 so that the opening 61a faces the front side 3-1 of the casing 3. The regeneration agent container 62 may be inserted into or withdrawn from the dissolution tank 61 through the opening 61a. As indicated by an imaginary line in FIG. 2, the regeneration agent container 62 is withdrawable from the front side 3-1 of the casing 3.

The regeneration agent container 62 may include a regeneration agent holding portion 62a having an open top surface and holding a regeneration agent S, a handle 62b provided in front of the regeneration agent holding portion 62a, and a lid portion 62c for opening and closing an opening of the regeneration agent holding portion 62a. An inner area of the regeneration agent holding portion 62a is divided into an upper space 60U and a lower space 60D by a partition wall 63 having therein a plurality of slits 63a with a width less than that of the regeneration agent S (salt particle). An inner water pipe 64 protruding backward is provided at the rear of the lower space 60D.

A water collection tank 61b is provided below a front portion of the dissolution tank 61. An upper end of a brine drainpipe 65 is connected to a bottom of the water collection tank 61b. A lower end of the brine drainpipe 65 is connected to the tub 4.

A sensor may be installed on an upper side of the rear of the dissolution tank 61. The sensor may be used to detect whether the regeneration agent container 62 is accommodated in the dissolution tank 61 at a closed position.

An outer water pipe 66 protruding backward is provided at a lower side of the rear of the dissolution tank 61. One end of the regeneration water pipe 43 is connected to the outer water pipe 66. The regeneration agent container 62 is accommodated in the dissolution tank 61 at the closed position so that the inner water pipe 64 is inserted into the outer water pipe 66. A seal material is mounted on an inner surface of the outer water pipe 66 so that the inner water pipe 64 enters or exits the outer water pipe 66 while maintaining a watertight seal.

As the regeneration agent container 62 is accommodated in the dissolution tank 61 at the closed position, the regeneration water pipe 43 is connected to the inside of the regeneration agent container 62 through the inner water pipe 64. The regeneration water may be supplied to the regeneration agent container 62. When the regeneration water fills up the lower space 60D, the regeneration water flows into the upper space 60U through the slits 63a. Thus, a high-concentration brine is produced.

The regeneration agent container 62 is inserted in or withdrawn from the dissolution tank 61. During the insertion or withdrawal, the regeneration water may leak. When the regeneration water leaks, the regeneration water needs to be wiped off with a rag or the like because it contains a high concentration of salt, and the regeneration agent S may not be effectively used to regenerate the ion exchange resin 23 but discarded.

However, because the regeneration agent container unit 60 according to the embodiment of the disclosure has a substantially inverted triangular cross-section, this shape allows the regeneration water to be easily collected in a lower portion thereof and thus suppresses the regeneration water from leaking. Furthermore, the regeneration agent container 62 is formed to have a bottom surface 67b inclined to a greater extent than a bottom surface of the dissolution tank 61 towards a rear side thereof.

By properly installing the washing machine 1, the bottom surface 67b of the regeneration agent container 62 is downwardly inclined toward the rear side. The inner water pipe 64, the outer water pipe 66, and the regeneration water pipe 43 are also configured to be inclined downwardly toward rear sides thereof. Accordingly, the regeneration water may not remain in the dissolution tank 61 and the regeneration agent container 62, and almost all the regeneration water may be drained out of the dissolution tank 61 and the regeneration agent container 62 through the regeneration water pipe 43.

As described above, because each of the dissolution tank 61 and the regeneration agent container 62 has a shape that makes it difficult for the regeneration water to stagnate and remain, leakage of the regeneration water may be suppressed during entry and exit of the regeneration agent container 62 to and from the dissolution tank 61.

### Modified Example

The above-described embodiment is described with respect to an example in which the regeneration agent container 62 of the regeneration agent container unit 60 is configured to be withdrawable from a front upper portion of the casing 3, i.e., the first corner region 15UL. On the other hand, a regeneration agent inlet 80 capable of being opened or closed may be provided on the front side 3-1 of the casing 3 so that a regeneration agent S may be put into the regeneration agent container unit 60 through the regeneration agent inlet 80.

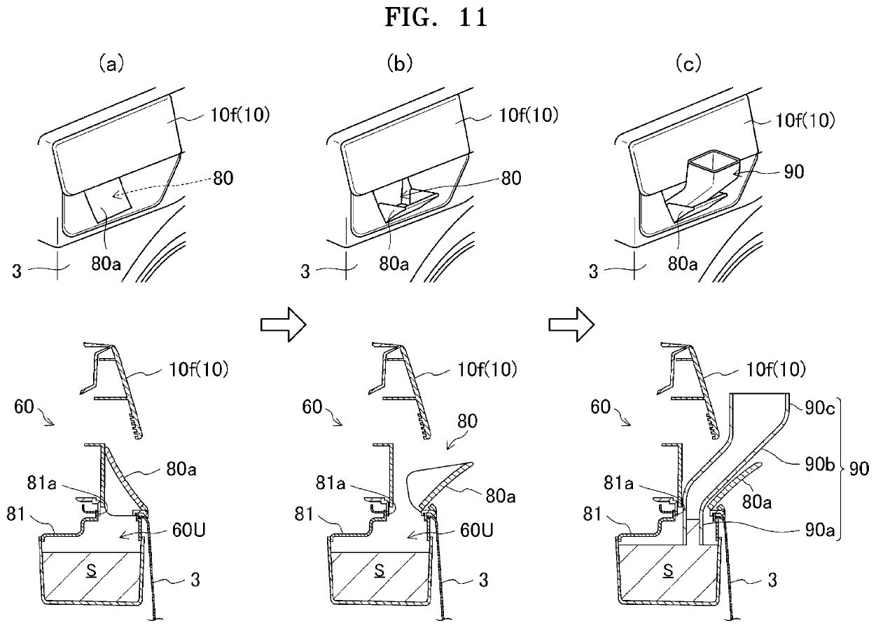

FIG. 11 illustrates the washing machine 1 according to an embodiment of the disclosure. An arrangement or a main structure of the regeneration agent container unit 60 are the same as those in the embodiments of the disclosure described with reference to FIGS. 1 through 10. Thus, a difference from the washing machine 1 shown in FIGS. 1 through 10 is described, like elements are denoted by like reference numerals, and descriptions provided above are omitted below. Referring to FIG., in the washing machine 1 according to the embodiment of the disclosure, the regeneration agent inlet 80 capable of being opened or closed is provided on the front side 3-1 of the casing 3 so that the regeneration agent S may be put into the regeneration agent container unit 60.

Referring to illustrations (a) and (b) of FIG. 11, the regeneration agent container unit 60 may include the regeneration agent inlet 80 and an integrated dissolution tank 81. The regeneration agent inlet 80 may be provided on the front side 3-1 of the casing 3 so that the regeneration agent S may be loaded into the regeneration agent container unit 60, e.g., the integrated dissolution tank 81. For example, the regeneration agent inlet 80 may be installed in the handle of the pull-out cover 10f of the detergent container 10b. A slider 80a opens and closes the regeneration agent inlet 80. The slider 80a may have a “U” shape with a cross-section being laid down. A lower edge of the slider 80a is rotatably supported on the regeneration agent inlet 80. By rotating the slider 80a, the regeneration agent inlet 80 may be opened and closed.

The slider 80a may partially protrude farther forward than the handle of the pull-out cover 10f at a position where the regeneration agent inlet 80 is opened. In addition, at the position where the regeneration agent inlet 80 is opened, the slider 80a may maintain a shape with an inner surface upwardly inclined toward the front. In other words, the slider 80a may have a first end toward the regeneration agent inlet 80 and a second end opposite to the regeneration agent inlet 80. At the position where the regeneration agent inlet 80 is opened, the second end may protrude farther forward than the handle of the pull-out cover 10f and be located above the first end and further forward than the first end. Thus, the regeneration agent S may be dropped into the regeneration agent inlet 80 further forward than the handle of the pull-out cover 10f.

The integral dissolution tank 81 may be a laterally (in the lateral direction) elongated member having a substantially inverted triangular cross-section corresponding to the shape of the first corner region 15UL, and is mounted to the casing 3 so that it is located in the first corner region 15UL. The integral dissolution tank 81 has a regeneration agent receiving port 81a at its top. As the detergent container 10b is accommodated in the detergent container case 10a, the regeneration agent receiving port 81a is located below and connected to the regeneration agent inlet 80.

Although not shown in FIG. 11, like in the regeneration agent container 62 described above, an inner area of the integrated dissolution tank 81 is divided into an upper space 60U and a lower space 60D by a partition wall 63 having a plurality of slits 63a formed therein. A water pipe protruding downward is provided at a bottom of the lower space 60D. One end of the regeneration water pipe 43 is connected to the water pipe.

Accordingly, as shown in the illustration (b) of FIG. 11, the regeneration agent inlet 80 may be opened by manipulating the slider 80a when the detergent container 10b is accommodated in the detergent container case 10a. Then, when the regeneration agent S is introduced through the regeneration agent inlet 80, the regeneration agent S may be received in the upper space 60U of the integrated dissolution tank 81 through the regeneration agent receiving port 81a. When the regeneration water fills up the lower space 60D, the regeneration water flows into the upper space 60U through the slits 63a. Thus, a high-concentration brine is produced.

In an embodiment of the disclosure, the regeneration agent container unit 60 may further include an auxiliary loader 90 detachable from the regeneration agent inlet 80 in order to load a given amount of regeneration agent into the regeneration agent container unit 60, e.g., the dissolution tank 81.

The auxiliary loader 90 is shown in illustration (c) of FIG. 11. The auxiliary loader 90 may be a tubular member that is insertable into and removable from the regeneration agent inlet 80. In an embodiment of the disclosure, the auxiliary loader 90 may include an insertion portion 90a, a support portion 90b, and an inlet portion 90c. The insertion portion 90a is inserted into the dissolution tank 81 through the regeneration agent inlet 80. In other words, when the auxiliary loader 90 is placed in the regeneration agent inlet 80, the insertion portion 90a is inserted into the dissolution tank 81, i.e., the upper space 60U, through the regeneration agent receiving port 81a of the dissolution tank 81. The support portion 90b extends upward from the insertion portion 90a and is supported by the slider 80a in a state in which the insertion portion 90a is inserted into the dissolution tank 81. The inlet portion 90c extends upward from the support portion 90b, and is provided with a funnel that opens upwardly at an upper end thereof.

When the insertion portion 90a of the auxiliary loader 90 is put in the opened regeneration agent inlet 80, the insertion portion 90a is inserted into the dissolution tank 81 through the regeneration agent receiving port 81a, so that the auxiliary loader 90 may be properly mounted to the regeneration agent container unit 60 in a predetermined state. By attaching the auxiliary loader 90 to the regeneration agent container unit 60, the funnel is located above the regeneration agent inlet 80 and in front of the pull-out cover 10f. Thus, use of the auxiliary loader 90 simplifies an operation of loading the regeneration agent S.

In addition, by attaching the auxiliary loader 90 to the regeneration agent inlet 80 to put the regeneration agent S into the dissolution tank 81, a preset amount of regeneration agent S may be introduced into the dissolution tank 81.

In detail, when the auxiliary loader 90 is placed inside the regeneration agent inlet 80, a position of a lower end of the insertion portion 90a in the dissolution tank 81, i.e., the upper space 60U, may be set so that a volume that is a preset amount greater than (or substantially the same volume as) an internal volume of the auxiliary loader 90 remains in the dissolution tank 81, i.e., the upper space 60U. In other words, in a state in which the insertion portion 90a is inserted into the dissolution tank 81, a volume (residual volume) of a space in the dissolution tank 81 above the lower end of the insertion portion 90a may be greater than or equal to the internal volume of the auxiliary loader 90.

Due to this configuration, when the regeneration agent S is put into the dissolution tank 81 using the auxiliary loader 90, as shown in a lower diagram of the illustration (c) of FIG. 11, the dissolution tank 81, i.e., the upper space 60U is filled with the regeneration agent S up to the position of the lower end of the insertion portion 90a. Thereafter, even when the regeneration agent S is continuously loaded, the regeneration agent S no longer fills up the dissolution tank 81, i.e., the upper space 60U but starts to fill the auxiliary loader 90.

When it is determined that the regeneration agent S starts to accumulate in the auxiliary loader 90, loading of the regeneration agent S is stopped, and the auxiliary loader 90 is removed. When the auxiliary loader 90 is removed, the regeneration agent S filled in the auxiliary loader 90 flows down into the dissolution tank 81, i.e., the upper space 60U. Because the residual volume is greater than or equal to the internal volume of the auxiliary loader 90, the regeneration agent S inside the auxiliary loader 90 is introduced into and received in the dissolution tank 81, i.e., the upper space 60U without overflowing outside. Thus, even when the amount of the regeneration agent S is not measured, an appropriate amount of the regeneration agent S may be loaded into the dissolution tank 81.

In the above-described embodiments of the disclosure, the regeneration agent container unit 60 and the hardness component remover 20 are respectively arranged in the first and second corner regions 15UL and 15UR, but the scope of the disclosure is not limited thereto. For example, the hardness component remover 20 may be located in the third or fourth corner region 15LL or 15LR. Various arrangement examples in which the regeneration agent container unit 60 and the hardness component remover 20 are arranged in different regions may be implemented. Furthermore, the regeneration agent container unit 60 may partially occupy and use the upper region 15U in addition to the first corner region 15UL. The hardness component remover 20 may partially occupy and use the upper region 15U in addition to the second corner region 15UR.

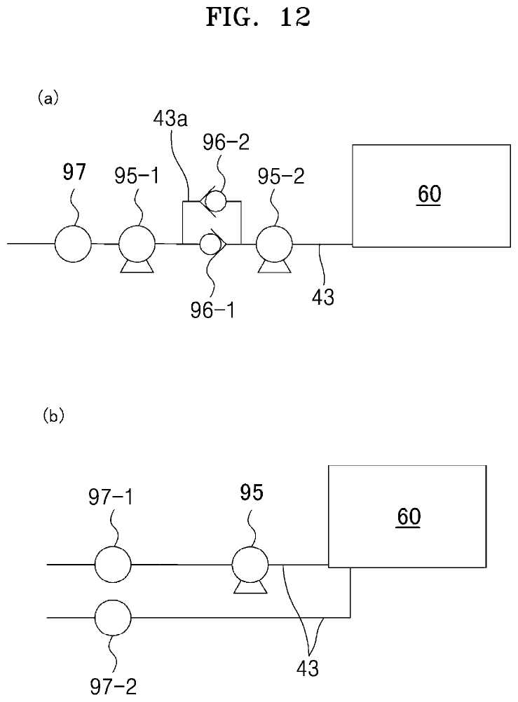

Although a peristaltic pump and one water supply path are employed in the above-described embodiments, other embodiments may be implemented. FIG. 12 shows examples of a combination of a water supply path and a pump. First, referring to an illustration (a) of FIG. 12, a first check valve 96-1 that allows fluid to flow from the pool tank 40 to the regeneration agent container unit 60 and a second check valve 96-2 that allows fluid to flow from the regeneration agent container unit 60 to the pool tank 40 may be arranged parallel to each other on a water supply path, e.g., the regeneration water pipe 43. A pump includes a first pump 95-1 for transferring fluid from the pool tank 40 to the regeneration agent container unit 60, and a second pump 95-2 for transferring fluid from the regeneration agent container unit 60 to the pool tank 40. For example, the first and second pumps 95-1 and 95-2 may be centrifugal pumps. An electronic valve 97 may open and close the water supply path, e.g., the regeneration water pipe 43.

Referring to an illustration (b) of FIG. 12, the water supply path, e.g., the regeneration water pipe 43, may have such a form of a circulation path between the pool tank 40 and the regeneration agent container unit 60. First and second electronic valves 97-1 and 97-2 and a pump 95 may be arranged in the circulation path. The pump 95 may be, for example, a centrifugal pump. The pump 95 circulates fluid along the circulation path. When the first and second electronic valves 97-1 and 97-2 are turned on, the circulation path is opened, and when turned off, the circulation path is closed. Accordingly, when the first and second electronic valves 97-1 and 97-2 are respectively turned on and off, the fluid is transferred from the pool tank 40 to the regeneration agent container unit 60, and when the first and second electronic valves 97-1 and 97-2 are respectively turned off and on, the fluid is transferred from the regeneration agent container unit 60 to the pool tank 40.

While embodiments of the disclosure have been particularly described above with reference to the figures, it will be understood that the scope of the disclosure is not limited to the embodiments of the disclosure and various modifications and improvements made by those of ordinary skill in the art based on a basic concept of the disclosure also fall within the scope as defined by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A drum type washing machine comprising:
a tub formed in a cylindrical shape and including a rotating drum configured to receive laundry;
a casing including a receiving region in which the tub is accommodated, an upper region above the receiving region, and four corner regions arranged around the tub; and
a water softening device including:
a hardness component remover configured to remove hardness components from wash water supplied to the tub, and
a regeneration agent container unit spaced apart from the hardness component remover on opposite sides from a center of the tub, and configured to hold a regeneration agent that regenerates a function of the hardness component remover.

2. The drum type washing machine of claim 1, wherein the regeneration agent container unit is located in a first of the four corner regions.

3. The drum type washing machine of claim 2, wherein the hardness component remover is located in a second of the four corner regions that is different from the first of the four corner regions.

4. The drum type washing machine of claim 1, wherein:
the four corner regions comprise first and second corner regions adjacent to the upper region and laterally spaced apart from each other on opposite sides from the center of the tub, and
the regeneration agent container unit and the hardness component remover are respectively arranged in the first and second corner regions.

5. The drum type washing machine of claim 1, further comprising a detergent container case provided between the water softening device and the tub and configured to hold detergent,
wherein the detergent container case is located in the upper region, and
wherein the regeneration agent container unit is located below the detergent container case.

6. The drum type washing machine of claim 5, wherein the detergent container case includes a detergent container accommodated in the detergent container case to be withdrawable from a front side of the casing in order to load the detergent.

7. The drum type washing machine of claim 5, wherein:
the detergent container case is located further toward one side of the upper region in a lateral direction with respect to the center of the tub, and
the four corner regions comprise first and second corner regions adjacent to the upper region and laterally spaced apart from each other on opposite sides from the center of the tub, and
the regeneration agent container unit is located in the first corner region below the detergent container case.

8. The drum type washing machine of claim 7, wherein the regeneration agent container unit has a substantially inverted triangular cross-section.

9. The drum type washing machine of claim 7, wherein the regeneration agent container unit comprises a dissolution tank and a regeneration agent container accommodated in the dissolution tank and configured to be withdrawable from a front side of the casing in order to load the regeneration agent.

10. The drum type washing machine of claim 7, wherein a regeneration agent inlet capable of being opened or closed is provided on a front side of the casing to load the regeneration agent into the regeneration agent container unit.

11. The drum type washing machine of claim 10, further comprising an auxiliary loader detachable from the regeneration agent inlet to load a given amount of the regeneration agent into the regeneration agent container unit.

12. The drum type washing machine of claim 11, wherein:
the regeneration agent container unit comprises a dissolution tank,
the auxiliary loader comprises an insertion portion inserted into the dissolution tank through the regeneration agent inlet, and
a volume of an upper space in the dissolution tank above a lower end of the insertion portion is greater than or equal to an internal volume of the auxiliary loader.

13. The drum type washing machine of claim 1, wherein the water softening device comprises:
a pool tank provided between a detergent container case and the hardness component remover and temporarily holding soft water;
a water supply path connecting the pool tank to the regeneration agent container unit; and
a pump configured to:
supply the soft water from the pool tank to the regeneration agent container unit, and
supply water treated for regeneration from the regeneration agent container unit to the pool tank.

14. The drum type washing machine of claim 13, wherein the pump comprises a peristaltic pump capable of bidirectionally supplying water.

15. The drum type washing machine of claim 13, wherein:
a first check valve that allows fluid to flow from the pool tank to the regeneration agent container unit is arranged in parallel in the water supply path to a second check valve that allows fluid to flow from the regeneration agent container unit to the pool tank, and
the pump comprises:
a first pump configured to transfer the fluid from the pool tank to the regeneration agent container unit, and
a second pump configured to transfer the fluid from the regeneration agent container unit to the pool tank.

16. The drum type washing machine of claim 13, wherein a sensor is installed in the pool take to measure an electrical conductivity inside the pool tank, which is used to determine a level and a degree of hardness of water collected in the pool tank.

17. The drum type washing machine of claim 1, wherein the hard component remover includes a resin case with a water passage space through which water flows.

18. The drum type washing machine of claim 17, wherein the water passage space is sequentially divided into an upstream buffer space, a resin-filled chamber, and a downstream buffer space.

19. The drum type washing machine of claim 18, wherein the resin-filled chamber is densely filled with ion exchange resins that absorb hardness components.

20. The drum type washing machine of claim 19, wherein the upstream and downstream buffer spaces include a mesh with pores that are smaller that a particle size of the ion exchange resins to maintain the ion exchange resins within the resin-filled chamber.
